(19) United States
(12) Patent Application Publication
(10) Pub. No.: US 2010/0302231 A1
(43) Pub. Date: Dec. 2, 2010

(54) SELF-EMISSION TYPE DISPLAY DEVICE WITH HEAT SINK

(75) Inventors: Du-Zen Peng, Jhubei City (TW); Ryuji Nishikawa, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CHIMEI INNOLUX CORPORATION, Miao-Li County (TW)

(21) Appl. No.: 12/783,625

(22) Filed: May 20, 2010

(30) Foreign Application Priority Data
May 25, 2009 (TW) 98117265

(51) Int. Cl. G06F 3/038; G09G 3/32

(52) U.S. Cl. 345/214; 345/82

(57) ABSTRACT

A system for displaying images is provided. The system includes a self-emission type display device including an organic light-emitting device interposed between a first substrate and a second substrate, a driving chip, and a thermal conductive layer. The first substrate has a pixel region and a peripheral circuit region. The second substrate is disposed above the first substrate and located at the pixel region. The driving chip is disposed on the first substrate and located at the peripheral circuit region, having a temperature sensor to detect the temperature of the organic light-emitting device. The thermal conductive layer is disposed on the bottom surface of the first substrate that corresponds to the organic light-emitting device and the driving chip.

This Application claims priority of Taiwan Patent Application No. 098117265, filed on May 25, 2009, the entirety of which is incorporated by reference herein.

### BACKGROUND OF THE INVENTION

1. Field of the Invention

The invention relates to a flat panel display (FPD), and in particular to a self-emission type display device with a thermal conductive layer, capable of precisely detecting the temperature of the display device.

2. Description of the Related Art

The demand for flat panel displays, such as self-emission type displays, has increased rapidly in recent years. Self-emission type displays, typically employ an organic light-emitting diode (OLED) as a light-emitting device in a pixel region for displaying images. Additionally, self-emission type displays employ an integrated circuit (IC) chip having a complementary metal oxide semiconductor (CMOS) circuit in a peripheral circuit region (i.e. driving circuit region). OLEDs typically comprise an anode, a cathode, and an organic light emissive layer disposed therebetween. When an electrical potential difference is applied between the anode and the cathode, electrons are injected into the light emissive layer from the cathode. At the same time, holes are injected into the light emissive layer from the anode. The injected electrons and holes are recombined at the light emissive layer, releasing energy as light.

However, heat is generated from the OLED when operated to display images. Thus, the greater the generated heat is and longer the generated heat time period is, the greater display brightness and lifespan thereof is negatively affected. In particular, the temperature of OLED is greatly increased when the OLED is operated to display chroma image or white image.

Referring to FIG. 1, which illustrates a cross section of a conventional self-emission type display device 10. The self-emission type display device 10 includes a lower glass substrate 100, an upper glass substrate 104, an organic light-emitting device 102 located at a pixel region P and between the two glass substrates 100 and 104, and a driving chip 106 located at a peripheral circuit region D. In order to solve the reduction of image quality due to the temperature variation of the self-emission type display device 10, a temperature sensor 106a is typically disposed within the driving chip 106 to detect the temperature of the organic light-emitting device 102, thereby compensating or adjusting a driving current according to the detected temperature, such that the brightness of the self-emission type display device 10 can be maintained. However, since there is a distance d between the driving chip 106 and the organic light-emitting device 102, the detected temperature is extremely different from the actual temperature of the organic light-emitting device 102 and thus it is difficult to effectively and accurately adjust the driving current.

Therefore, there exists a need in the art for development of a self-emission type display device structure, capable of precisely detecting the temperature of a display device.

### BRIEF SUMMARY OF THE INVENTION

A detailed description is given in the following embodiments with reference to the accompanying drawings. Systems for displaying images are provided. An exemplary embodiment of a system for displaying images comprises a self-emission type display device comprising an organic light-emitting device interposed between a first substrate and a second substrate, a driving chip, and a thermal conductive layer. The first substrate has a pixel region and a peripheral circuit region. The second substrate is disposed above the first substrate and located at the pixel region. The driving chip is disposed on the first substrate and located at the peripheral circuit region, having a temperature sensor to detect the temperature of the organic light-emitting device. The thermal conductive layer is disposed on the bottom surface of the first substrate that corresponds to the organic light-emitting device and the driving chip.

Another exemplary embodiment of a system for displaying images comprises a self-emission type display device comprising an organic light-emitting device interposed between a first substrate and a second substrate, a driving chip, and a thermal conductive layer. The first substrate has a pixel region and a peripheral circuit region. The second substrate is disposed above the first substrate and located at the pixel region. The driving chip is disposed on the first substrate and located at the peripheral circuit region, having a temperature sensor to detect the temperature of the organic light-emitting device. The thermal conductive layer covers at least a portion of the top surface of the second substrate and at least a portion of the top surface of the driving chip.

### BRIEF DESCRIPTION OF DRAWINGS

The invention can be more fully understood by reading the subsequent detailed description and examples with references made to the accompanying drawings, wherein:

FIG. 1 is a cross section of a conventional self-emission type display device.

FIG. 2A is a cross section of an embodiment of a system for displaying images including a self-emission type display device according to the invention;

FIG. 2B is a cross section of another embodiment of a system for displaying images including a self-emission type display device according to the invention;

FIG. 2C is a cross section of another embodiment of a system for displaying images including a self-emission type display device according to the invention;

FIG. 3 is a cross section of another embodiment of a system for displaying images including a self-emission type display device according to the invention;

FIG. 4 is a cross section of another embodiment of a system for displaying images including a self-emission type display device according to the invention; and

FIG. 5 schematically shows another embodiment of a system for displaying images.

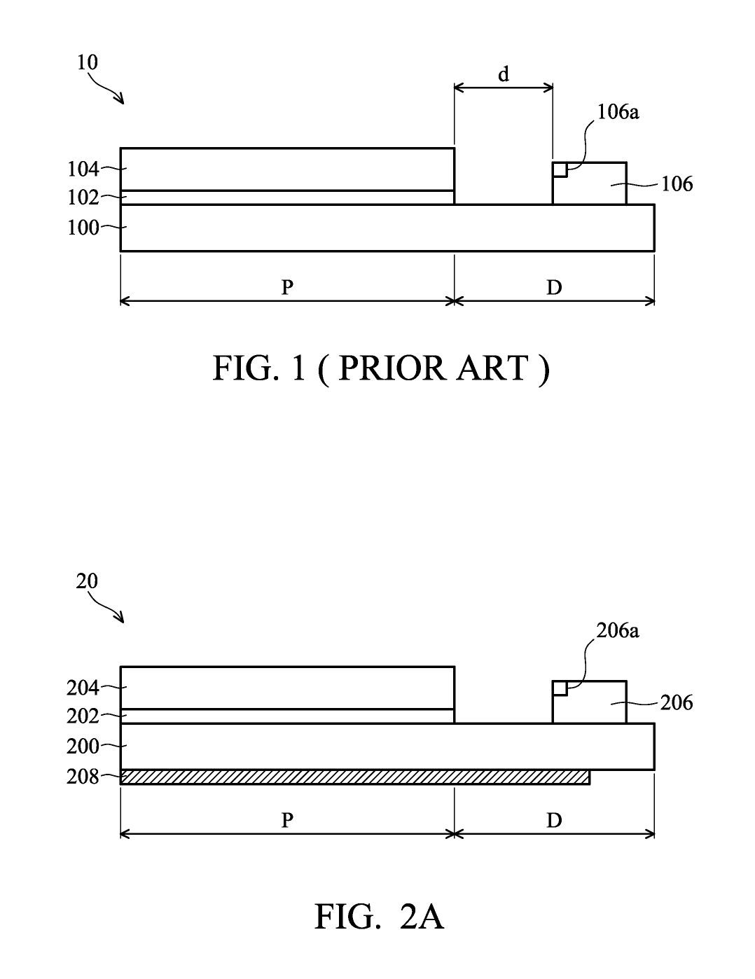

### DETAILED DESCRIPTION OF INVENTION

The following description is of the best-contemplated mode of carrying out the invention. This description is provided for the purpose of illustrating the general principles of the invention and should not be taken in a limiting sense. The scope of the invention is best determined by reference to the appended claims.

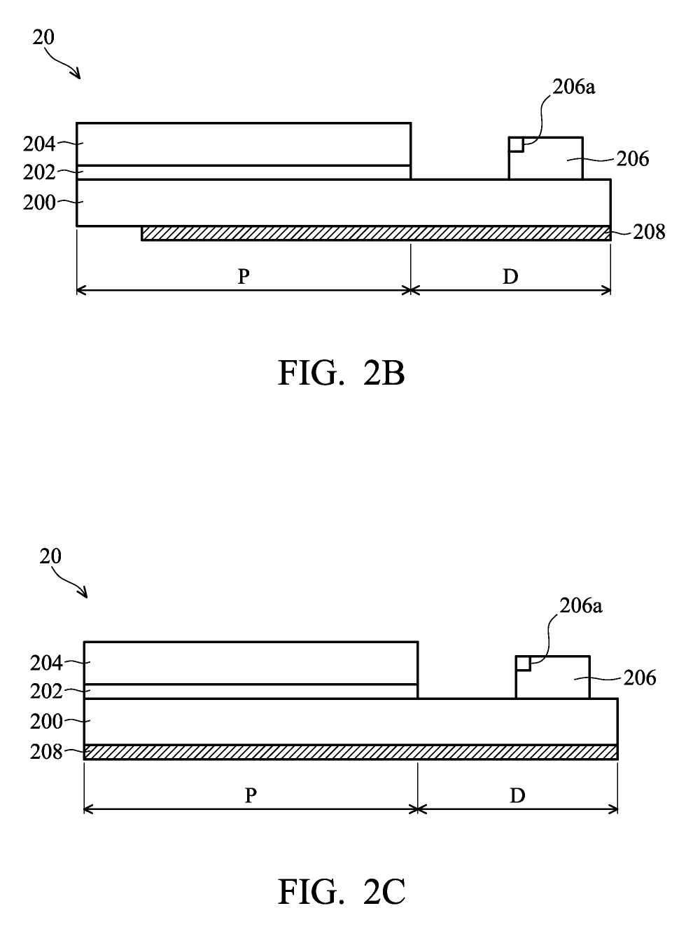

Systems for displaying images are provided. Referring to FIG. 2A, which illustrates an embodiment of a system for displaying images including a self-emission type display device 20 according to the invention. The self-emission type display device 20, such as an organic light-emitting display device, comprises a first substrate 200, a second substrate 204, an organic light-emitting device 202, a driving chip 206, and a thermal conductive layer 208.

The first substrate has a pixel region P and a peripheral circuit region D and may comprise glass, quartz, or other transparent materials.

The organic light-emitting device 202 is disposed on the top surface of the first substrate 200 and located at the pixel region P. In one embodiment, the organic light-emitting device 202 comprises a plurality of organic light-emitting diodes arranged in an array. Moreover, the organic light-emitting device 202 may be a top-emission type organic light-emitting device.

The driving chip is disposed on the top surface of the first substrate 200 and located at the peripheral circuit region D. Moreover, the driving chip 206 is electrically connected to the organic light-emitting device 202 for controlling image display thereof. In the embodiment, the driving chip 206 has a temperature sensor 206a to detect the temperature of the organic light-emitting device 202. Additionally, note that the position of the temperature sensor 206a is based on the actual circuit design and is not limited to the position of the temperature sensor 206a shown in FIG. 2A.

The second substrate 204 is disposed on the organic light-emitting device 202 and corresponds to the pixel region P of the first substrate 200, such that the organic light-emitting device 202 is interposed between the first substrate 200 and the second substrate 204. Also, the second substrate may comprise glass, quartz, or other transparent materials.

The thermal conductive layer 208 is disposed on the bottom surface of the first substrate 200 that corresponds to the organic light-emitting device 202 and the driving chip 206, such that the thermal conductive layer 208 overlaps at least a portion of the organic light-emitting device 202 and at least a portion of the driving chip 206. In the embodiment, the thermal conductive layer 208 serves as a heat sink and may be a thin film comprising metal or aluminum nitride. Heat generated from the organic light-emitting device 202 may be conducted to the thermal conductive layer 208 by the first substrate 200, and uniformly distributed over the thermal conductive layer 208.

In the embodiment, the thermal conductive layer 208 overlaps the entire organic light-emitting device 202 and a portion of the driving chip 206.

Moreover, when the temperature of the organic light-emitting device 202 is raised due to generation of heat from the operated organic light-emitting device 202, the detecting distance of the temperature sensor 206a can be reduced because the driving chip 206 is overlapped with the thermal conductive layer 208. In other words, the temperature sensor 206a can precisely detect the actual temperature of the organic light-emitting device 202. Accordingly, although there is still a distance between the driving chip 206 and the organic light-emitting device 202, the temperature sensor 206a still can precisely detect the actual temperature of the organic light-emitting device 202. As a result, the driving chip 206 can effectively adjust the driving current according to the temperature detected by the temperature sensor 206a. Accordingly, the brightness of the self-emission type display device 20 can be controlled precisely, thereby maintaining the image quality of display device.

In another embodiment, the thermal conductive layer 208 overlaps a portion of the organic light-emitting device 202 and the entire driving chip 206, as shown in FIG. 2B.

In further another embodiment, the thermal conductive layer 208 overlaps the entire organic light-emitting device 202 and the entire driving chip 206, as shown in FIG. 2C.

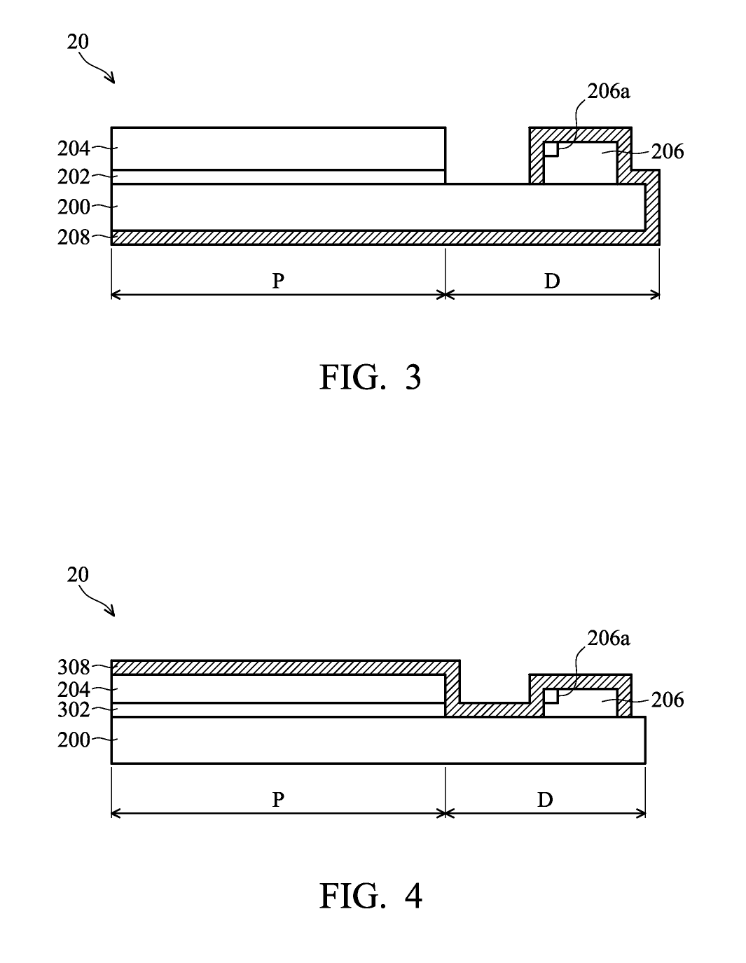

Referring to FIG. 3, which illustrates another embodiment of a system for displaying images including a self-emission type display device according to the invention. Elements in FIG. 3 that are the same as those in FIG. 2A are labeled with the same reference numbers as in FIG. 2A and are not described again for brevity. Unlike the embodiments above, the thermal conductive layer 208 further extends to cover the top and side surfaces of the first substrate 200 and conformally covers the top and both side surfaces of the driving chip 206. The detecting distance of the temperature sensor 206a can be further reduced because the surface of the driving chip 206 is covered by the thermal conductive layer 208. Additionally, compared to the conventional self-emission type display device or the embodiments above, the temperature sensor 206a can detect the actual temperature of the organic light-emitting device 202 more precisely.

Referring to FIG. 4, which illustrates another embodiment of a system for displaying images including a self-emission type display device according to the invention. Elements in FIG. 4 that are the same as those in FIG. 2A are labeled with the same reference numbers as in FIG. 2A and are not described again for brevity. Unlike the embodiments above, the organic light-emitting device 302 is a bottom-emission type organic light-emitting device. Moreover, the thermal conductive layer 308 conformally covers at least a portion of the top surface of the second substrate 204 and at least a portion of the top surface of the driving chip 206.

In one embodiment, for example, the thermal conductive layer 308 fully covers the top surface of the second substrate 204 and partially covers the top surface of the driving chip 206. In another embodiment, the thermal conductive layer 308 partially covers the top surface of the second substrate 204 and fully covers the top surface of the driving chip 206. In yet another embodiment, the thermal conductive layer 308 fully covers the top surfaces of the second substrate 204 and the driving chip 206. In order to simplify the diagram, an exemplary embodiment of the thermal conductive layer 308 fully covering the top surfaces of the second substrate 204 and the driving chip 206 is depicted, as shown in FIG. 4.

According to such an embodiment, the detecting distance of the temperature sensor 206a can be further reduced because the surface of the driving chip 206 is covered by the thermal conductive layer 308. Accordingly, the temperature sensor 206a can detect the actual temperature of the organic light-emitting device 302 more precisely.

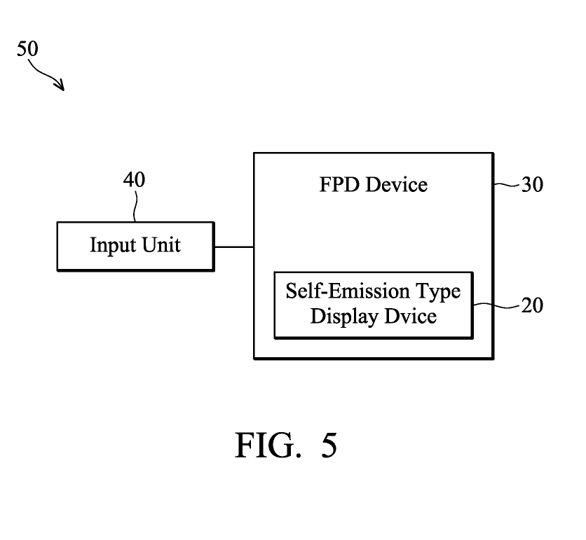

FIG. 5 schematically shows another embodiment of a system for displaying images which, in this case, is implemented as a flat panel display (FPD) device 30 or an electronic device 50, such as a laptop computer, a mobile phone, a digital camera, a personal digital assistant (PDA), a desktop computer, a television, a car display or a portable DVD player. The described self-emission type display device 20 can be incorporated into the flat panel display device 30 that can be an OLED display. In some embodiments, the self-emission type display device 20 can be incorporated into the electronic device 50. As shown in FIG. 5, the electronic device 50 comprises the FPD device 30 and an input unit 400. Moreover, the input unit 40 is coupled to the FPD device 30 and operative to provide input signals (e.g. image signals) to the FPD device 30 to generate images.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images, comprising:
a self-emission type display device, comprising:
a first substrate having a pixel region and a peripheral circuit region;
a second substrate disposed above the first substrate and located at the pixel region;
an organic light-emitting device interposed between the first substrate and the second substrate;
a driving chip disposed on the first substrate and located at the peripheral circuit region, having a temperature sensor to detect the temperature of the organic light-emitting device; and
a thermal conductive layer disposed on the bottom surface of the first substrate that corresponds to the organic light-emitting device and the driving chip.

2. The system of claim 1, wherein the thermal conductive layer overlaps the entire organic light-emitting device and the entire driving chip.

3. The system of claim 1, wherein the thermal conductive layer overlaps the entire organic light-emitting device.

4. The system of claim 1, wherein the thermal conductive layer overlaps the entire driving chip.

5. The system of claim 1, wherein the thermal conductive layer extends to cover the top and side surfaces of the first substrate and the top and both side surfaces of the driving chip.

6. The system of claim 1, wherein the thermal conductive layer comprises metal or aluminum nitride.

7. The system as claimed in claim 1, further comprising:
a flat panel display device comprising the self-emission type display device; and
an input unit coupled to the flat panel display device and operative to provide input singles to the flat panel display device, such that the flat panel display device displays images.

8. The system of claim 7, wherein the system comprises an electronic device comprising the flat panel display device.

9. The system of claim 8, wherein the electronic device is a laptop computer, a mobile phone, a digital camera, a personal digital assistant, a desktop computer, a television, a car display or a portable DVD player.

10. A system for displaying images, comprising:
a self-emission type display device, comprising:
a first substrate having a pixel region and a peripheral circuit region;
a second substrate disposed above the first substrate and
an organic light-emitting device interposed between the first substrate and the second substrate;
a driving chip disposed on the first substrate and located at the peripheral circuit region, having a temperature sensor to detect the temperature of the organic light-emitting device; and
a thermal conductive layer covering at least a portion of the top surface of the second substrate and at least a portion of the top surface of the driving chip.

11. The system of claim 10, wherein the thermal conductive layer fully covers the top surfaces of the second substrate and the driving chip.

12. The system of claim 10, wherein the thermal conductive layer fully covers the top surface of the second substrate.

13. The system of claim 10, wherein the thermal conductive layer fully covers the top surface of the driving chip.

14. The system of claim 10, wherein the thermal conductive layer comprises metal or aluminum nitride.

15. The system as claimed in claim 11, further comprising:
a flat panel display device comprising the self-emission type display device; and
an input unit coupled to the flat panel display device and operative to provide input singles to the flat panel display device, such that the flat panel display device displays images.

16. The system of claim 15, wherein the system comprises an electronic device comprising the flat panel display device.

17. The system of claim 16, wherein the electronic device is a laptop computer, a mobile phone, a digital camera, a personal digital assistant, a desktop computer, a television, a car display or a portable DVD player.
